(19) United States
(12) Patent Application Publication
(10) Pub. No.: US 2026/0300556 A1
(43) Pub. Date: Oct. 1, 2026

(54) CRITICAL DATA MANAGEMENT AMONG PEER DATA STORAGE DEVICES

(71) Applicant: Sandisk Technologies, Inc., Milpitas, CA (US)

(72) Inventors: GOPI KUPPAN THIRUMALAI, Bangalore (IN); RAMANATHAN MUTHIAH, Bangalore (IN); Judah Gamliel HAHN, Bangalore (IN)

(73) Assignee: Sandisk Technologies, Inc., Milpitas, CA (US)

(21) Appl. No.: 19/089,211

(22) Filed: Mar. 25, 2025

(51) Int. Cl. G06F 21/79; G06F 21/60

(52) U.S. Cl. CPC G06F 21/79; G06F 21/602; G06F 21/606

(57) ABSTRACT

A storage server may manage critical data on one or more storage devices in the storage server. The storage server includes a system controller to manage interactions between storage devices. A storage device may store its control information, the control information for another storage device and a network map on the server may represent the mapping of critical information across the storage devices. An SSD controller on a first storage device may periodically flush critical information to a destination storage device. The SSD controller may determine that the critical information is inaccessible on the first storage device and that the first storage device is inoperable. The SSD controller may identify the destination storage device based on the network map, request the critical information from the destination storage device, and proceed with operations on the first storage device using the critical information received from the destination storage device.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store user data in pages on blocks on the memory device. During an initial boot or after the manufacturing process, the storage device may construct essential management information and meta block table details (referred to herein as crucial data structures). Each of these crucial data structures may be critical for identifying the usability of storage blocks and ensuring that the storage device functions properly. For example, the storage device may store critical information, including information about its capacity, manufacturer details, and other vital parameters needed to properly access and manage the storage device in a system information block (SIB) on the memory device. The storage device may store the crucial data structures at a first location (referred to herein as a crucial memory area) on the memory device. During use, the storage device may access the crucial data structures in the crucial memory area.

The storage device may encounter data loss due to factors such as physical damage to the memory device, firmware error, power outages, etc. The crucial data structures needed to properly access and manage the storage device may become susceptible to complete loss or damage when the firmware on the storage device is corrupted or when there is hardware malfunction on the storage device. For example, when a crucial memory area is damaged, the storage device may be unable to access the crucial data structure(s), possibly causing the storage device to become non-functional and enter a non-detectable or brick state wherein the storage device may be unusable to the host, causing the storage device to enter a read only mode and/or leading to significant data loss.

To safeguard the crucial data structure(s), the storage device may implement protection mechanisms such as error-correcting codes (ECCs), wear leveling, and may backup the crucial data structures on one or more different locations on the memory device (i.e., locations that are different from the crucial memory area) to create a recovery option if the crucial memory area is compromised. However, these measures may be insufficient during catastrophic failures on the storage device if, for example, all of the storage blocks holding the crucial data structure(s) are damaged. In an example where a given number of backups of crucial data structure(s) (for example two copies of the SIB, boot block, etc.) are stored in backup locations on the storage device and there is physical damage to storage device such that the crucial memory area and the backup locations become inaccessible, current backup methods may be ineffective and the crucial data structure(s) may be lost.

### SUMMARY OF THE INVENTION

In some implementations, a storage server may safeguard and manage critical data on one or more storage devices in the storage server. The storage server includes a system controller to manage interactions between storage devices on the storage server. A storage device may store its control information, the control information for another storage device, and a network map of the storage server that may represent the mapping of critical information across the storage devices. An SSD controller on a first storage device may periodically flush critical information to a destination storage device. The SSD controller may determine that the critical information is inaccessible on the first storage device and that the first storage device is inoperable. The SSD controller may identify the destination storage device based on the network map, request the critical information from the destination storage device, and proceed with operations on the first storage device using the critical information received from the destination storage device.

In some implementations, a storage server may enable debugging on a storage device where critical information is inaccessible using a debugging tool. The storage server may include a system controller to manage interactions between storage devices on the storage server. A storage device may store its control information, the control information for another storage device, and a network map of the storage server that may represent the mapping of critical information across the storage devices. The storage server may include an SSD controller on a first storage device to periodically flush critical information to a second storage device and determine that the critical information is inaccessible on the first storage device and a debug tool connected to the first storage device is inoperable. The system controller identifies a second storage device based on the network map and enables the debug tool to connect to the second storage device. The debug tool uses the critical information received from the first storage device and stored on the second storage device to debug the first storage device.

In some implementations, a method is provided on the storage device for managing critical data on one or more storage devices in the storage server. The method includes managing, by the system controller, interactions between storage devices on the storage server. The method also includes periodically flushing, by SSD controller on a first storage device, critical information to a destination storage device and determining that the critical information is inaccessible on the first storage device and the first storage device is inoperable. The method further includes identifying, by the SSD controller, the destination storage device based on a network map, requesting the critical information from the destination storage device; and proceeding with operations on the first storage device using the critical information received from the destination storage device.

### BRIEF DESCRIPTION OF THE DRAWINGS

FIG. 1 is a schematic block diagram of an example system in accordance with some implementations.

FIG. 2 is a block diagram of an exemplary network map used in accordance with some implementations.

FIG. 3 is an example flow diagram for triggering a periodic data flush on an operational storage device 104 in accordance with some implementations.

FIG. 4 is an example flow diagram for recovering critical information for a first storage device from a second storage device in accordance with some implementations.

FIG. 5 is an example flow diagram for debugging a non-functioning storage device in accordance with some implementations.

FIG. 6 is a diagram of an example environment in which systems and/or methods described herein are implemented.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

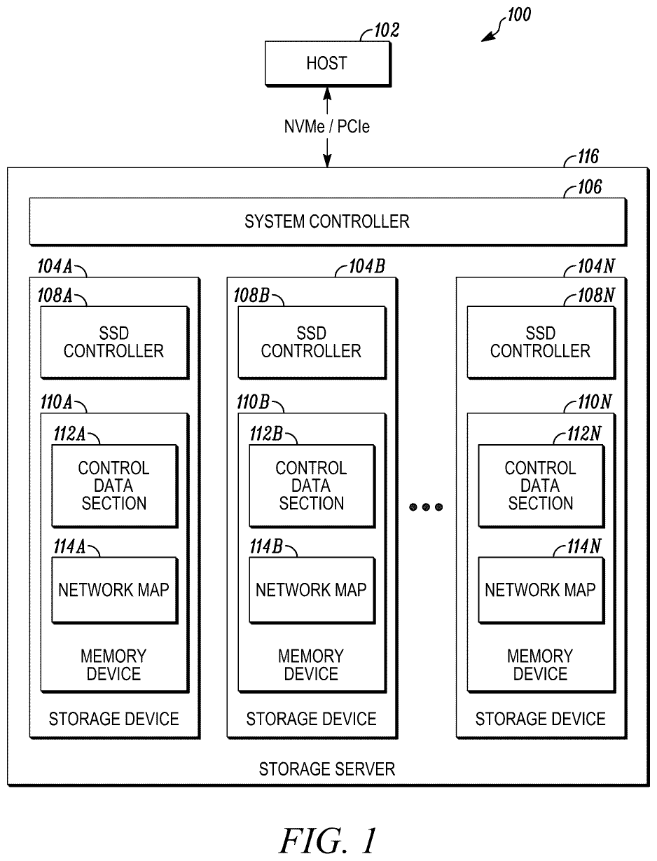

FIG. 1 is a schematic block diagram of an example system in accordance with some implementations. System 100 may include a host 102 and a storage server 116 including storage device 104a-104n (referred to herein as the storage device(s) 104) and a system controller 106 to manage interactions between storage devices 104. Host 102 and storage server 116 may be in the same physical location as components on a single computing device or on different computing devices that are communicatively coupled. Storage server 116 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage devices 104 may be, for example, a solid-state drive (SSD) that may include storage device controllers 108a-108n (generally referred to herein as SSD controller(s) 108) and one or more storage components such as non-volatile memory devices 110a-110n (referred to herein as the memory device(s) 110). SSD controller 108 may interface with host 102 and process foreground operations including instructions transmitted from host 102. For example, SSD controller 108 may read data from and/or write to memory devices 110 based on instructions received from host 102. SSD controller 108 may also execute background operations to manage resources on memory device 110. For example, SSD controller 108 may monitor memory devices 110 and may execute garbage collection and other relocation functions per internal relocation algorithms to refresh, recycle, and/or relocate the data on memory devices 110.

Memory devices 110 may be flash based. For example, memory devices 110 may be a NAND or NOR flash memory that may be used for storing host and control data over the operational life of memory devices 110. Memory devices 110 may include one or more dies connected to a memory bus including data lines and chip enable lines. The dies may be divided into blocks and data may be stored in the blocks in various formats, with the formats being defined by the number of bits that may be stored per memory cell. Memory device 110 may be included in storage device 104 or may be otherwise communicatively coupled to storage device 104.

Memory device 110 in each storage device 104 may include a control data section 112a-112n (referred to herein as the control data section(s) 112) and a network map 114a-114n (referred to herein as the network map(s) 114). During an initial bootup or after the manufacturing process, SSD controller 108 on a storage device 104 may construct critical data structures/information for the management and use of storage device 104. For example, SSD controller 108 on storage device 104 may construct critical information including boot blocks, encryption keys, diagnostic data, and other essential system information associated with storage device 104. A storage device 104 may store its critical information and the critical data structures of one or more other storage devices 104 in its control data section 112.

Each storage device 104 may create backups that may be stored in different locations within the attached memory device 110. For example, storage device 104a may save its critical information in control data section 112a on memory device 110a and store backups of its critical information in different locations (locations other than control data section 112a) in memory device 110a. An implementation may safeguard critical information on storage devices 104 by allowing device specific critical information to be disbursed across storage server 116. For example, critical information for storage device 104a may be stored in control data section(s) 112b-112n on one or more storage devices 104b-104n.

System controller 106 may create an initial network map 114 and manage the interactions between storage devices 104. During operations, system controller 106 may use network map 114 for data retrieval and system control. Network map 114 may represent the mapping of critical information across multiple storage devices 104. For example, network map 114 may show that critical information for a first storage device 104 (for example, storage device 104a) is stored on one of more of other storage devices (for example, storage devices 104b-104n).

Network map 114 may include entries with unique identifiers for storage devices 104a-104n and associated control information reference. The control information reference in an entry associated with, for example, the first storage device may point to one or more other storage devices that may include the critical information for the first storage device 104. As such, each storage device 104 may use its network map 114 to identify location(s) in server 116 where its critical data structures are stored. In the event of a failure on, for example, the first storage device 104 such that the first storage device 104 is unable to access its critical information stored in its control data section 112 or in backup locations on an attached memory device 110, the first storage device 104 may use network map 114 to identify the one or more other storage devices that are currently storing the critical information for the first storage device 104. The first storage device 104 may access its critical information stored on a storage device 104 identified in network map 114.

In an implementation, the first storage device 104 may periodically flush device specific critical information to one or more other storage devices 104 (referred to herein as a destination/second storage device(s) 104). The first storage device 104 may use its network map 114 to determine one or more destination storage devices 104 on which to store its critical information. For example, storage device 104a may periodically flush its critical information to one or more other storage devices 104b-104n. The first storage device 104 may periodically flush log data to destination storage device(s) 104. For example, at logical points associated with logging data, state machine information, and/or monitoring the health status of the first storage device 104, first storage device 104 may periodically flush log data to destination storage device(s) 104. The periodic flushing of log data may contribute to early detection of potential issues on the first storage device 104, thereby improving overall system reliability.

The first storage device 104 may also periodically flush debug data from individual modules or cores of first storage device 104 to memory device 110 of one or more destination storage device(s) 104. For example, storage device 104a may periodically flush debug data from individual modules or cores on storage device 104a to memory device 110b associated with destination storage device 10b. The periodic flushing of debug data may ensure that detailed debugging information is readily available for analysis.

The critical information for the first storage device 104 may be encrypted prior to being stored on destination storage device(s) 104. The associated decryption keys may be available to one or more storage devices 104 as determined based on the information in network map 114. For example, the decryption keys may be available to storage device 104a when storage device 104a is shown in network map 114 to be the owner of the critical information. The flash translation layer(s) in the destination storage device(s) 104 may additionally provide biased protection for the critical information associated with the first storage device 104.

In a network of storage devices 104, as shown, for example, using storage server 116, an implementation may enable recovery of critical information for the first storage device 104 (for example, storage device 104a) and an environment to debug failure on the first storage device 104. In an example where storage device 104a encounters a failure in reading its bad block information during a boot process, the critical information including bad block details that were previously stored on control data section 112a may be inaccessible to storage device 104a. Storage device 104a may reference network map 114 to identify destination storage device(s) 104 that is storing the critical information associated with storage device 104a.

During the boot process with the failure, when storage device 104a fails to read its bad block information from memory device 110a, SSD controller 108a on storage device 104a may consult network map 114a. SSD controller 108a may determine, based on network map 114 information, that the bad block information for storage device 104a is also stored on storage device 104b. Storage device 104a may establish a secure communication channel with storage device 104b via, for example, system controller 106 and storage device 104a may request the necessary bad block details from storage device 104b. Storage device 104b may securely transmit the bad block information for storage device 104a to storage device 104a. Storage device 104b may encrypt the bad block information for storage device 104a prior to transmitting the bad block information to storage device 104a. When storage device 104a receives the bad block information from storage device 104b, storage device 104a may decrypt and verify the integrity of the received bad block information. System controller 108 may dynamically update network map 114 to reflect the retrieval of the bad block information by storage device 104a and as such, the entry in network map 114 associated with storage device 104a may point to the latest control information to ensure accuracy. With the retrieved bad block information, storage device 104a may proceed with the boot process without being blocked. As such, server 116 may maintain operational continuity on storage device 104a despite the failure of storage device 104a during the boot process.

In an example where the critical information for storage device 104a is damaged or lost unexpectedly, storage device 104a may malfunction, enter read-only (RO) mode, and/or become unusable (for example, enter a bricked state), possibly causing data consistency errors on storage device 104a. Storage device 104a may be in a mode of operation where debugging of storage device 104a may not be feasible. For example, when the critical information for storage device 104a and the backup of the critical information are inaccessible, a debugging tool attached to storage device 104a may not work because of the inaccessible critical information and backups on storage device 104a.

In an example where the first storage device (for example, storage device 104a) is unable to access its critical information and is in a mode of operation where debugging on the first storage device is not feasible, system controller 106 may use network map 114 to identify a working storage device (for example, storage device 104b also referred to as a second storage device). System controller 106 may enable the debug tool to be attached to the second storage device. The control information for the first storage device 104a may be stored in control data section 112b, i.e., the control data section of the second storage device. SSD controller 108b may load a debug image of the failing storage device (in this example, storage device 104a) in debug mode. The debug tool attached to the working/second storage device (in this example, storage device 104b) may use the control information for the first storage device 104a stored in control data section 112b to debug the non-working storage device 104a.

Storage device 104 may perform these processes based on one or more distinct processors, for example, system controller 106 and/or SSD controller(s) 108 executing software instructions stored by a non-transitory computer-readable medium, such as storage component/memory device 110. As used herein, the term “computer-readable medium” refers to a non-transitory memory device. Software instructions may be read into storage component 110 from another computer-readable medium or from another device. When executed, software instructions stored in storage component 110 may cause one or more distinct processors including, for example, system controller 106 and/or SSD controller(s) 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

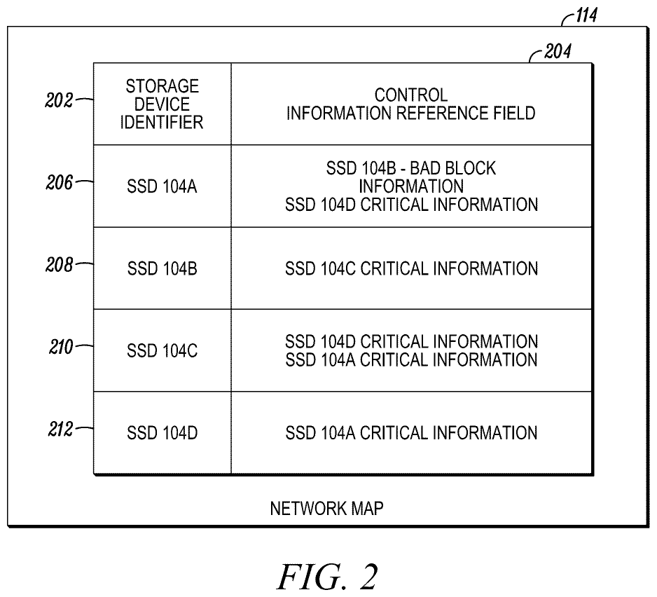

FIG. 2 is a block diagram of an exemplary network map used in accordance with some implementations. Network map 114 may include a storage device identifier field 202 and a control information reference field 204. In an example where server 116 includes four storage devices (storage device (SSD) 104a-104d), an entry in network map 114 may be associated with each storage device 104a-104d. For example, entry 206 may include an identifier for storage device 104a and a pointer to one or more other storage devices (i.e., 104b-104d) where critical information for storage device 104a is stored. Network map 114 in this example shows that storage device 104b is storing the bad block information for storage device 104a and storage device 104d is storing critical information, possibly including the bad block information, for storage device 104a. Entry 208 may include an identifier for storage device 104b and a pointer to storage device 104c where critical information for storage device 104b is stored; entry 210 may include an identifier for storage device 104c and a pointer to other storage devices 104a and 104d where critical information for storage device 104c is stored; and entry 212 may include an identifier for storage device 104d and a pointer to storage device 104a where critical information for storage device 104d is stored. A storage device 104 may use network map 114 to locate its critical information so that the storage device may resolve issues associated with accessing its critical information and continuing its operation. By dispersing the critical information for a storage device 104 across one or more storage devices 104, server 116 may ensure reliability and resilience. As indicated above FIG. 2 is provided as an example. Other examples may differ from what is described in FIG. 2.

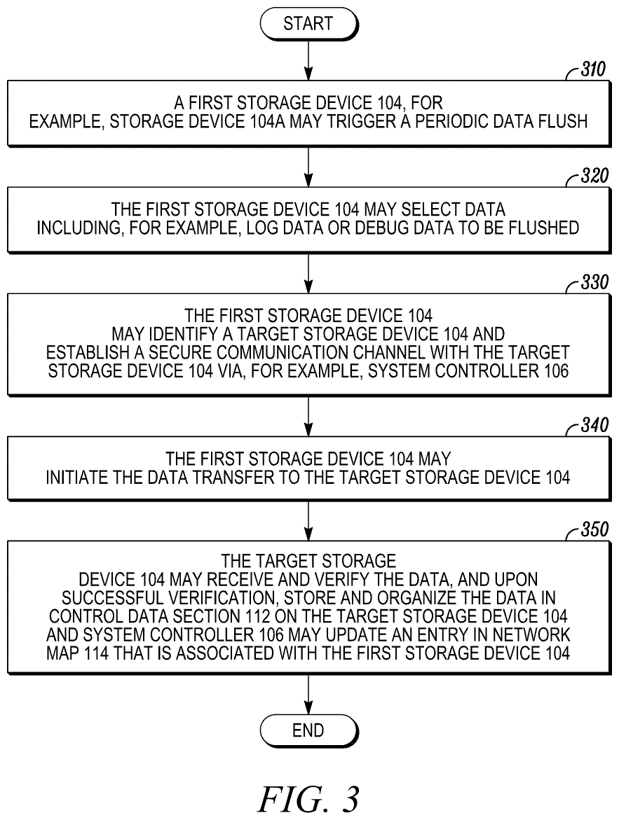

FIG. 3 is an example flow diagram for triggering a periodic data flush on an operational storage device 104 in accordance with some implementations. At 310, a first storage device 104, for example, storage device 104a may trigger a periodic data flush. At 320, the first storage device 104 may select data including, for example, log data or debug data to be flushed. At 330, the first storage device 104 may identify a target storage device 104 and establish a secure communication channel with the target storage device 104 via, for example, system controller 106. At 340, the first storage device 104 may initiate the data transfer to the target storage device 104. At 350, the target storage device 104 may receive and verify the data, and upon successful verification, store and organize the data in control data section 112 on the target storage device 104 and system controller 106 may update an entry in network map 114 that is associated with the first storage device 104. As indicated above FIG. 3 is provided as an example. Other examples may differ from what is described in FIG. 3.

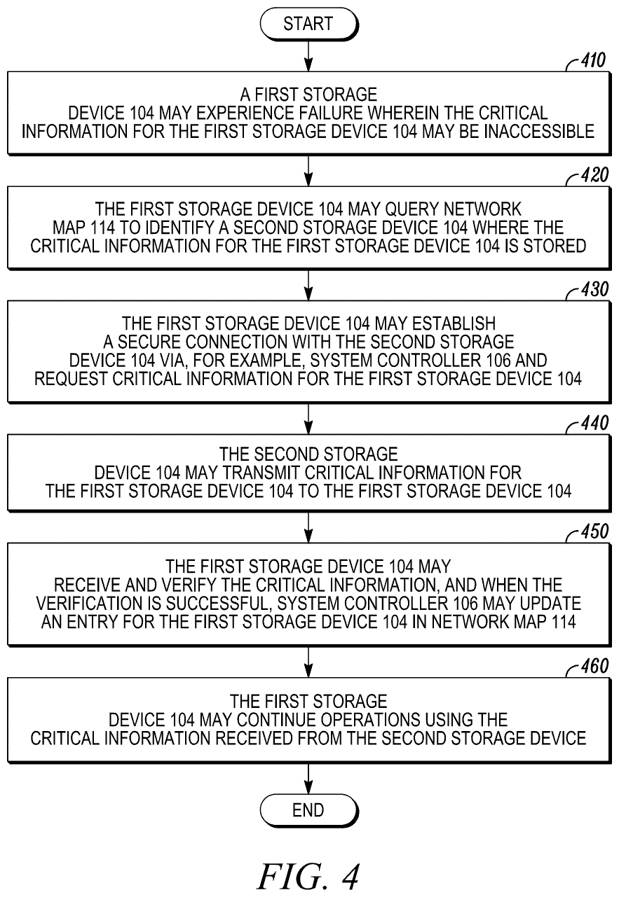

FIG. 4 is an example flow diagram for recovering critical information for a first storage device from a second storage device in accordance with some implementations. At 410, a first storage device 104 may experience failure wherein the critical information for the first storage device 104 may be inaccessible. At 420, the first storage device 104 may query network map 114 to identify a second storage device 104 where the critical information for the first storage device 104 is stored. At 430, the first storage device 104 may establish a secure connection with the second storage device 104 via, for example, system controller 106 and request critical information for the first storage device 104. At 440, the second storage device 104 may transmit critical information for the first storage device 104 to the first storage device 104. At 450, the first storage device 104 may receive and verify the critical information, and when the verification is successful, system controller 106 may update an entry for the first storage device 104 in network map 114. At 460, the first storage device 104 may continue operations using the critical information received from the second storage device. As indicated above FIG. 4 is provided as an example. Other examples may differ from what is described in FIG. 4.

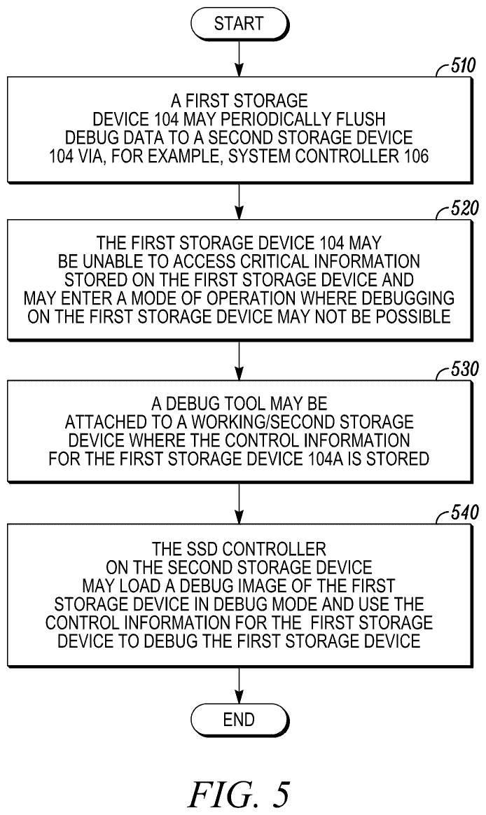

FIG. 5 is an example flow diagram for debugging a non-functioning storage device in accordance with some implementations. At 510, a first storage device 104 may periodically flush debug data to a second storage device 104 via, for example, system controller 106. At 520, the first storage device 104 may be unable to access critical information stored on the first storage device and may enter a mode of operation where debugging on the first storage device may not be possible. At 530, a debug tool may be attached to a working/second storage device where the control information for the first storage device 104a is stored. At 540, the SSD controller on the second storage device may load a debug image of the first storage device in debug mode and use the control information for the first storage device to debug the first storage device. As indicated above FIG. 5 is provided as an example. Other examples may differ from what is described in FIG. 5.

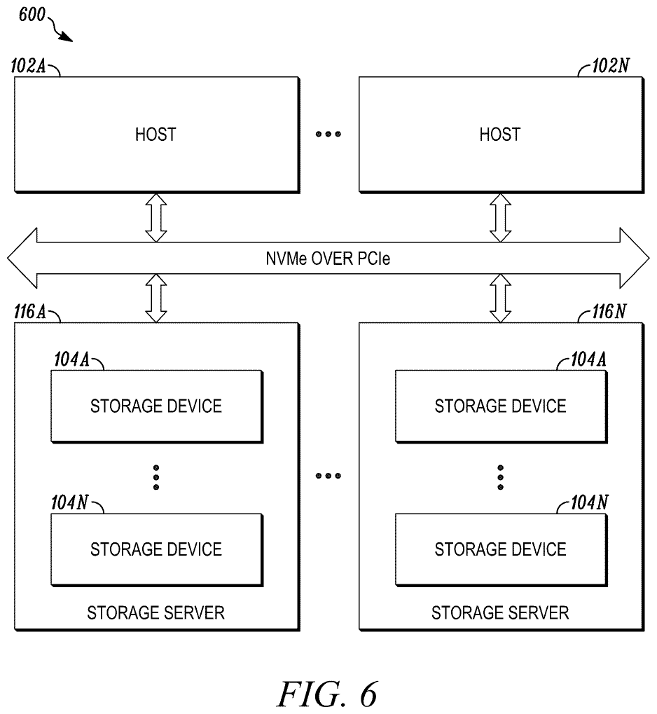

FIG. 6 is a diagram of an example environment in which systems and/or methods described herein are implemented. As shown in FIG. 6, Environment 600 may include hosts 102-102n (referred to herein as host(s) 102), and one or more storage servers 116a-116n (referred to herein as storage server(s) 116). Storage servers 116 may safeguard and manage critical data on one or more storage devices 104. Hosts 102 and storage servers 116 may communicate via Non-Volatile Memory Express (NVMe) over peripheral component interconnect express (PCI Express or PCIe), SD, or the like.

Devices of Environment 600 may interconnect via wired connections, wireless connections, or a combination of wired and wireless connections. For example, the network in FIG. 6 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of Environment 600 may perform one or more functions described as being performed by another set of devices of Environment 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage server to safeguard and manage critical data on one or more storage devices in the storage server, the storage server comprises:
a system controller to manage interactions between storage devices on the storage server, wherein the storage devices store control information and include a network map; and
a first storage device controller on a first storage device to periodically flush critical information on the first storage device to a destination storage device, to determine that the critical information is inaccessible on the first storage device and the first storage device is inoperable, to identify the destination storage device based on the network map, request the critical information from the destination storage device, and proceed with operations on the first storage device using the critical information received from the destination storage device.

2. The storage device of claim 1, wherein the first storage device controller establishes a connection with a second storage device controller on the destination storage device via the system controller.

3. The storage device of claim 1, wherein the critical information is encrypted prior to being transmitted on the destination storage device and a decryption key for encrypted critical information is available to the first storage device as determined based on the network map.

4. The storage device of claim 1, wherein a flash translation layer in the destination storage device provides biased protection for the critical information.

5. The storage device of claim 1, wherein the first storage device periodically flushes at least one of log data and debug data to the destination storage device.

6. The storage device of claim 1, wherein the first storage device periodically flushes log data to the destination storage device at logical points associated with at least one of logging data, state machine information, and monitoring health status of the first storage device.

7. The storage device of claim 1, wherein the network map includes multiple storage devices with critical information for the first storage device and first storage device uses the network map to select the destination storage device.

8. The storage device of claim 1, wherein the first storage device stores its critical information and the critical information for another storage device in a control data section on the first storage device.

9. The storage device of claim 1, wherein the network map represents mapping of critical information across the storage devices.

10. The storage device of claim 1, wherein the network map includes an entry for the first storage device with an identifier for the first storage device and a control information reference that points to another storage device that includes the critical information for the first storage device.

11. A storage server to enable debugging on a storage device where critical information is inaccessible using a debug tool, the storage server comprises:
a system controller to manage interactions between storage devices on the storage server, wherein the storage devices store control information and include a network map; and
a first storage device controller on a first storage device to periodically flush critical information to a second storage device and to determine that the critical information is inaccessible on the first storage device and a debug tool connected to the first storage device is inoperable,
the system controller to identify the second storage device based on the network map, enable the debug tool to connect to the second storage device, where the debug tool uses the critical information received from the first storage device and stored on the second storage device to debug the first storage device.

12. The storage device of claim 11, wherein the network map represents mapping of critical information across the storage devices.

13. The storage device of claim 11, wherein the network map includes an entry for the first storage device with an identifier for the first storage device and a control information reference that points to other storage devices that include the critical information for the first storage device.

14. A method in a storage server for managing critical data on one or more storage devices in the storage server, the storage server comprises a system controller and a first storage device controller to execute the method comprising:
managing, by the system controller, interactions between storage devices on the storage server;
periodically flushing, by the first storage device controller, critical information to a destination storage device;
determining, by the first storage device controller, that the critical information is inaccessible on the first storage device and the first storage device is inoperable;
identifying, by the first storage device controller, the destination storage device based on a network map;
requesting, by the first storage device controller, the critical information from the destination storage device; and
proceeding, by the first storage device controller, with operations on the first storage device using the critical information received from the destination storage device.

15. The method of claim 14 further comprising establishing, by the first storage device controller, a connection with a second storage device controller on the destination storage device via the system controller.

16. The method of claim 14 further comprising periodically flushing, by the first storage device controller, at least one of log data and debug data to the destination storage device.

17. The method of claim 14 further comprising periodically flushing, by the first storage device controller, log data at logical points associated with at least one of logging data, state machine information, and monitoring health status of the first storage device.

18. The method of claim 14 further comprising including, by the system controller, multiple storage devices with critical information for the first storage device in the network map and using, by the first storage device controller, the network map to select the destination storage device.

19. The method of claim 14 further comprising storing, by the first storage device controller, the critical information for the first storage device and the critical information for another storage device in a control data section on the first storage device.

20. The method of claim 14 further comprising using, by the system controller, the network map to represent mapping of critical information across the storage devices.
